(19) United States
(12) Patent Application Publication
(10) Pub. No.: US 2023/0274156 A1
(43) Pub. Date: Aug. 31, 2023

(54) Low-Power Edge Computing with Optical Neural Networks via WDM Weight Broadcasting

(71) Applicants: Ryan HAMERLY, Cambridge, MA (US); Dirk Robert ENGLUND, Brookline, MA (US); Massachusetts Institute of Technology, Cambridge, MA (US)

(72) Inventors: Ryan HAMERLY, Cambridge, MA (US); Dirk Robert ENGLUND, Brookline, MA (US)

(73) Assignees: Massachusetts Institute of Technology, Cambridge, MA (US); NTT Research, Incorporated, Sunnyvale, CA (US)

(21) Appl. No.: 18/247,129

(22) PCT Filed: Jul. 29, 2021
(86) PCT No.: PCT/US2021/043593

§ 371 Date: Mar. 29, 2023

Related U.S. Application Data
(60) Provisional application No. 63/084,600, filed on Sep. 29, 2020.

(51) Int. Cl. G06N 3/098; G06N 5/04

(52) U.S. Cl. CPC G06N 3/098; G06N 5/04

(57) ABSTRACT

NetCast is an optical neural network architecture that circumvents constraints on deep neural network (DNN) inference at the edge. Many DNNs have weight matrices that are too large to run on edge processors, leading to limitations on DNN inference at the edge or bandwidth bottlenecks between the edge and server that hosts the DNN. With NetCast, a weight server stores the DNN weight matrix in local memory, modulates the weights onto different spectral channels of an optical carrier, and distributes the weights to one or more clients via optical links. Each client stores the activations, or layer inputs, for the DNN and computes the matrix-vector product of those activations with the weights from the weight server in the optical domain. This multiplication can be performed coherently by interfering the spectrally multiplexed weights with spectrally multiplexed activations or incoherently by modulating the weight signal from the weight server with the activations.

### CROSS-REFERENCE TO RELATED APPLICATION(S)

This application claims the priority benefit, under 35 U.S.C. 119(e), of U.S. application Ser. No. 63/084,600, filed Sep. 29, 2020, which is incorporated herein by reference in its entirety for all purposes.

### GOVERNMENT SUPPORT

This invention was made with Government support under Grant No. ECCS1344005 awarded by the National Science Foundation (NSF), and under Grant No. W911NF-18-2-0048 awarded by the Army Research Office (ARO). The Government has certain rights in the invention.

### BACKGROUND

Machine learning is becoming ubiquitous in edge computing applications, where large networks of low-power smart sensors preprocess their data remotely before relaying it to a central server. Since much of this preprocessing relies on deep neural networks (DNNs), great effort has gone into developing size, weight, and power (SWaP)-constrained hardware and efficient models for DNN inference at the edge. However, many state-of-the-art DNNs are so large that they can only be run in a data center, as their model sizes exceed the memories of SWaP-constrained edge processors. Such DNNs cannot be run on the edge, so sensors must transmit their data to the server for analysis, leading to severe bandwidth bottlenecks.

### SUMMARY

To address these problems with running DNN inference at the edge, we introduce NetCast, an optical neural network architecture that circumvents limitations on DNN size, allowing DNNs of arbitrary size to be run on SWaP-constrained edge devices. NetCast uses a server-client protocol and architecture that exploit wavelength-division multiplexing (WDM), difference detection and integration, optical weight delivery, and the extremely large bandwidth of optical links to enable low-power DNN inference at the edge for networks of arbitrary size, unbounded by the SWaP constraints of edge devices. This enables the edge deployment of whole new classes of neural networks that have heretofore been restricted to data centers.

More generally, NetCast provides a server-client architecture for performing DNN inference in SWaP-constrained edge devices. By broadcasting the synaptic weights optically from a central server, this architecture significantly reduces the memory and power requirements of the edge device, enabling data center-scale deep learning on low-power platforms that is not possible today.

The central server encodes a matrix (the DNN weights) into an optical pulse train. It transmits the encoded optical pulse train over a link (e.g., a free-space or fiber link, potentially with optical fan-out) and to one or more clients (edge devices). Each client uses a combination of optical modulation, wavelength multiplexing, and photodetection to compute the matrix-vector product Σₙwₘₙxₙ between the weights (received over the link) and the DNN layer inputs, also called activations, which are stored on the client. Many layers are run sequentially, allowing each client to perform inference for DNNs of arbitrary size and depth without needing to store the weights in memory.

This client-server architecture has several advantages over existing applications. At present, to perform deep learning on edge devices, there are limited options, each with its own drawback(s). These options include: (1) upload the data and run the DNN in the cloud at the cost of bandwidth, latency, and privacy issues; (2) run the full DNN on the edge device—but note the memory and power requirements often exceed the device's SWaP constraints; or (3) compress the DNN so that it can run with lower power and memory—often not possible, and will degrade the DNN's performance (classification accuracy, etc.). In contrast, the present technology can simultaneously provide local data storage, SWaP constraint satisfaction, and high-performing (uncompressed) DNNs.

Applications for the NetCast client-server protocol and architecture include: bringing high-performance deep learning to light-weight edge or fog devices in the Internet-of-Things; enabling low-power fiber-coupled smart sensors on advanced machinery (aircraft, cars, ships, satellites, etc.), distributing DNNs to large free-space sensor networks (e.g., for environmental monitoring, disaster relief, mining, oil/gas exploration, geospatial intelligence, or security). For highly utilized DNNs, data centers can also use the architecture to reduce the energy consumption of DNN inference.

NetCast can be implemented as follows. A server generates a weight signal comprising an optical carrier modulated with a set of spectrally multiplexed weights for a DNN, then transmits the weight signal to a client via an optical link The client receives the weight signal and computes a matrix-vector product of (i) the set of spectrally multiplexed weights modulated onto the optical carrier and (ii) inputs to a layer of the DNN. The server can store the set of spectrally multiplexed weights in its (local) memory and retrieve the set of spectrally multiplexed weights from its (local) memory.

The server can generate the weight signal by, at each of a plurality of time steps, modulating WDM channels of the optical carrier with respective entries of a column of a weight matrix of the DNN. In this case, the client can compute the matrix-vector product by modulating the weight signal with the inputs to the layer of the DNN, demultiplexing the WDM channels of the weight signal modulated with the input to the layer of the DNN, and sensing powers of the respective WDM channels of the weight signal modulated with the input to the layer of the DNN. The client can modulate the weight signal with the inputs to the layer of the DNN by intensity-modulating inputs to a Mach-Zehnder modulator with amplitudes of the inputs to the layer of the DNN and encoding signs of the inputs to the layer of the DNN with the Mach-Zehnder modulator.

The server can also generate the weight signal by modulating an intensity of the optical carrier with amplitudes of the set of spectrally multiplexed weights before coupling the optical carrier into a set of ring resonators and modulating the optical carrier with signs of the set of spectrally multiplexed weights using the ring resonators. Or the server can generate the weight signal by encoding the set of spectrally multiplexed weights in a complex amplitude of the optical carrier, in which case the client computes the matrix-vector product in part by detecting interference of the weight signal with a local oscillator modulated with the inputs to the layer of the DNN.

The spectrally multiplexed weights may form a weight matrix, in which case the client can compute the matrix-vector product by weighting columns of the weight matrix with the inputs to the layer of the DNN to produce spectrally multiplexed products; demultiplexing the spectrally multiplexed products; and detecting the spectrally multiplexed products with respective photodetectors. In this case, weighting the columns of the weight matrix with the inputs to the layer of the DNN may include simultaneously modulating a plurality of wavelength channels. Alternatively, the client can weight rows of the weight matrix with the inputs to the layer of the DNN to produce temporally multiplexed products and detecting the temporally multiplexed products with at least one (and perhaps only one) photodetector. In this case, weighting the rows of the weight matrix with the inputs to the layer of the DNN may include independently modulating each of a plurality of wavelength channels.

A NetCast system may include both a server and one or more clients. The server may include a first memory, a (laser) source, and a first modulator operably coupled to the first memory and the source. In operation, the first memory stores weights (a weight matrix) for the DNN. The source emits an optical carrier (e.g., a frequency comb). And the first modulator generates a weight signal comprising the weights modulated onto wavelength-division multiplexed (WDM) channels of the optical carrier. The client, which is operably coupled to the server via an optical link, includes a second memory, a second modulator, and a frequency-selective detector. In operation, the second memory stores activations for a layer of the DNN. The second modulator, which is operably coupled to the second memory, modulates the activations onto the weight signal, thereby generating a matrix-vector product of the weights and the activations. And the frequency-selective detector, which is operably coupled to the modulator, detects the WDM channels of the matrix-vector product.

The first modulator can modulate the WDM channels of the optical carrier with respective entries of a column of a weight matrix of the DNN over respective time steps. It can include micro-ring resonators configured to modulate WDM channels. The frequency-selective detector can include one pair of ring resonators for each WDM channel and one balanced detector for each pair of ring resonators.

In some cases, the first modulator can modulate signs of the weights onto the optical carrier, in which case the client further includes an intensity modulator, operably coupled to the first modulator, to modulate amplitudes of the weights onto the optical carrier. Similarly, the second modulator can modulate signs of the activations onto the weight signal, in which case the client includes at least one intensity modulator, operably coupled to the second modulator, to modulate amplitudes of the activations onto the weight signal.

A coherent NetCast system also includes a server and at least one client. The coherent NetCast server includes a first memory to store the weights for the DNN, a laser source to generate a frequency comb, and a frequency-selective modulator, operably coupled to the first memory and the laser source, to generate a weight signal comprising the weights modulated onto WDM channels of the frequency comb. The client is operably coupled to the server via an optical link and includes a second memory, a local oscillator (LO), a modulator, and a frequency-selective detector. The second memory stores activations for a layer of the DNN. The LO generates an LO frequency comb phase-locked to the frequency comb. The modulator is operably coupled to the second memory and to the LO and modulates the activations onto the LO frequency comb. And the frequency-selective detector is operably coupled to the modulator and detects interference of the weight signal and the LO frequency comb, thereby producing a matrix-vector product of the weight signals and the activations.

The frequency-selective modulator can include one pair of ring resonators for each of the WDM channels arranged on different arms of a Mach-Zehnder interferometer. The frequency-selective detector can include one pair of ring resonators for each of the WDM channels and one balanced detector for each pair of ring resonators.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates an architecture system called NetCast for low-power edge computing with optical neural networks (ONNs) via wavelength-division multiplexed (WDM) weight broadcasting. The NetCast system includes a weight server with a WDM transmitter array (left), an optical link (center), and a client with a modulator coupled to a WDM receiver array with difference detection and integration (right). For concreteness, FIG. 1 shows the WDM transmitter and receiver implemented with micro-ring arrays; however, they can be implemented with Mach-Zehnder modulators and/or other components too.

FIG. 2 illustrates data flow in the NetCast ONN of FIG. 1. A matrix-vector product is performed in N time steps, with M wavelength channels. In each time step n, the weights wₘₙ are encoded by adjusting the electrical inputs to the modulators in the WDM transmitter array (in this case detunings Δₘₙ of ring resonators). The through- and drop-port outputs αₘₙ^{(T)}=tₘₙαₘₙ^{(D)}=rₘₙα₀rₘₙα₀(Eq. (2)) are sent to the client, where a Mach-Zehnder modulator (MZM) mixes them to produce outputs αₘₙ⁽⁺⁾(Eq. (2)). The difference current in each wavelength channel gives the product wₘₙxₙ. After time integration, the products yₘ=Σₙwₘₙxₙ are read out.

FIG. 3 illustrates a coherent implementation of NetCast. The lines of a frequency comb are modulated independently with the DNN weights using a WDM-MZM (here a ring array-assisted MZM). On the client side, the signal is beat against a local oscillator (LO), modulated with the DNN layer inputs by another MZM, and the wavelength channels are read out separately in a WDM homodyne detector. The main extra complexity comes from stabilizing the phase, frequency, and line spacing of the LO comb.

FIG. 4A shows differences between Time Integration/Frequency Separation (TIFS) and Frequency Integration/Time Separation (FITS) integration schemes for NetCast.

FIG. 4B shows simple (upper row) and low noise (lower row) server and client schematics for incoherent detection with TIFS (left client column) or FITS (right client column).

FIG. 4C shows server and client schematics for coherent detection with TIFS (left client column) or FITS (right client column).

FIG. 5A is a plot of the MNIST DNN classification error as a function of noise amplitude σ in Eq. (14) for a small neural network (NN).

FIG. 5B is a plot of the MNIST DNN classification error as a function of noise amplitude σ in Eq. (14) for a large NN.

FIG. 6A is a schematic of wafer-scale NetCast weight server based on a wavelength-multiplexed log-depth switching tree.

FIG. 6B shows an aircraft with smart sensors coupled to a central server in a NetCast architecture.

FIG. 6C shows separate edge devices (e.g., drones) coupled to a central server via free-space optical links in a NetCast architecture.

FIG. 6D shows a data center with edge devices coupled to a central server via fiber links in a NetCast architecture.

FIG. 7A illustrates data flow for inference (solid arrows) and training (dashed arrows) through a single DNN layer.

FIG. 7B illustrates encoding of a weight update δₘₙ in time-frequency space, analogous to the encoding of Wₘₙ.

FIG. 7C shows incoherent server and simple (top row) and low-noise (bottom row) client designs for training a DNN.

FIG. 7D shows coherent server and client designs for training a DNN.

FIG. 8A illustrates combining weight updates from multiple clients using time interleaving for an incoherent scheme to suppress spurious interference and simple combining for a coherent scheme.

FIG. 8B illustrates incoherent combining hardware: MZI splitting tree (top) or passive junction with time delays (bottom, poor man's interleaver).

FIG. 8C illustrates passive signal combining in a coherent scheme.

### DETAILED DESCRIPTION

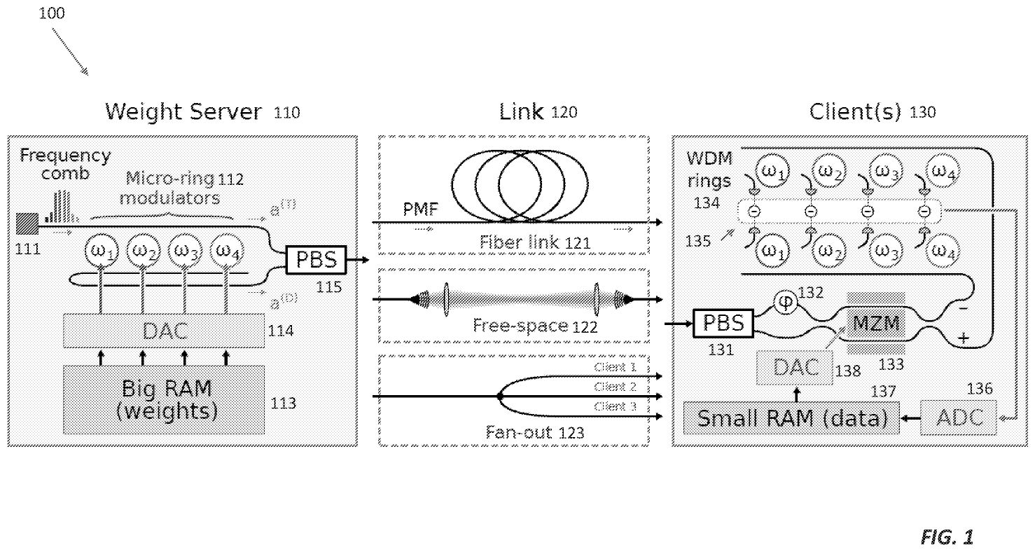

FIG. 1 illustrates a NetCast optical neural network 100, which includes a weight server 110 and one or more clients 130 connected by optical link(s) 120. (For clarity, FIG. 1 shows only one client 130.) The weight server 110 includes a light source, illustrated in FIG. 1 as a mode-locked laser 111 that generates an optical carrier in the form of a frequency comb (although coherence between the frequency channels is not necessary for incoherent NetCast). Other suitable light sources include arrays of lasers that emit at different frequencies. The weight server 110 also includes a broadband modulator, illustrated as a set of tunable, wavelength-division-multiplexed (WDM) modulators (here depicted as a micro-ring array) 112, whose input is optically coupled to the light source 111 and whose outputs are coupled to input ports of a polarizing beam splitter (PBS) 113 via a bus waveguide. In this example, there are four micro-ring modulators 112, each tuned to a different frequency ω₁ through ω₄. The micro-ring modulators 112 are driven with weights stored in a first memory—here, a random-access memory (RAM) 113 that stores the weight matrix for a DNN—by a multi-channel digital-to-analog converter (DAC) 114 that converts digital signals from the RAM 113 into analog signals suitable for driving the micro-ring modulators 112.

The output port of the beam splitter 113 is coupled to the optical link 120, which can be a fiber link 121 (e.g., polarization-maintaining fiber (PMF) or single-mode fiber (SMF) with polarization control at the output), free-space link 122, or optical link with fan-outs 123 for connecting to multiple clients 130. If the server 110 is connected to multiple clients 110, it can be connected to each client 110 via a different (type of) optical link 120. In addition, a given optical link 120 may include multiple segments, including multiple fiber or free-space segments connected by amplifiers or repeaters.

Each client 130 includes a PBS 131 with two output ports, which are coupled to respective input ports of a Mach-Zehnder modulator (MZM) 133 with a phase modulator 132 in the path from one PBS output to the corresponding MZM input. The outputs of the MZM 133 are demultiplexed into an array of difference detectors 135, one per wavelength channel. Demultiplexing can be achieved with various passive optics, including arrayed waveguide gratings, unbalanced Mach-Zehnder trees, and ring filter arrays (shown here). In the ring-based implementation, the light is filtered with banks of WDM ring resonators 134. The ring resonators 134 in each bank are tuned to the same resonance frequencies ω₁ through coo as the micro-ring modulators 112 in the client 110. Each resonator 134 is paired with a corresponding resonator in the other bank that is tuned to the same resonance frequency. These pairs of resonators 134 are evanescently coupled to respective differential detectors 135, such that each differential detector 135 is coupled to a pair of resonators 134 resonant at the same frequency (e.g., ω₁). In this arrangement, the pairs of resonators 134 act as passband filters that couple light at a particular frequency from the MZM 133 to the respective differential detectors 135.

The differential detectors 135 are coupled to an analog-to-digital converter (ADC) 136 that converts analog signals from the differential detectors 135 into digital signals that can be stored in a RAM 137. The RAM 137 also stores inputs to one or more layers of the DNN. The RAM 136 is coupled to a DAC 138 that is coupled in turn to the MZM 133. The DAC 138 drives the MZM 133 with the DNN layer inputs stored in the RAM 137 as described below.

The NetCast optical neural network 100 works as follows. Data is encoded using a combination of time multiplexing and WDM: the server 110 and client 130 perform an M×N matrix-vector product in N time steps over M wavelength channels. At each time step (indexed by n), the server 110 broadcasts a column wₙ of the weight matrix to the client 130 via the optical link 120. The server 110 modulates the weight matrix elements, which are stored in the RAM 113, on the frequency comb to produce a weight signal using the broadband modulator (e.g., micro-ring resonators 112). Then the server 110 transmits this weight signal to the client 130 via the optical link 120. The MZM 133 in the client 130 multiplies the weight signal with the input to the corresponding DNN layer, which is stored in the client RAM 137. The pair of 1-to-M WDMs (e.g., M ring resonators 134) and M difference photodetectors 135 (one set per wavelength) in the client 130 demultiplex the outputs of the MZM 133. These outputs are the products of the weights with the input vector stored in the client's RAM 137, wₘₙxₙ. Integrating over all N time steps, the total charge accumulated on each difference detector 135 is

γₘ=ΣₙWₘₙxₙ (1)

performing the desired matrix-vector product.

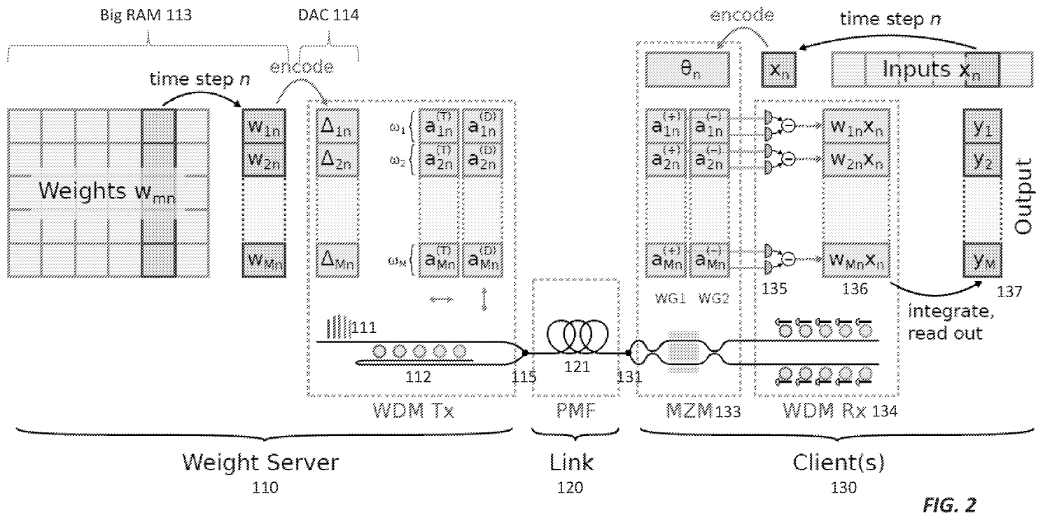

FIG. 2 shows the NetCast protocol in more detail for the optical neural network 100 of FIG. 1. Again, the server 110 includes a broadband WDM source 111 that emits an optical carrier with multiple channels, such as an optical frequency comb, and is coupled to a weight bank of micro-ring (or disk) modulators 112. Each micro-ring modulator 112 couples to a single WDM channel, transmits a fraction of its input power to the through port, which is coupled to a waveguide that is coupled to the upper port of the PBS 115. Each micro-ring modulator 112 reflects the rest of the input power to the drop port, which is coupled to a waveguide that is coupled to the lower port of the PBS 115. The difference between the power transmitted and reflected by the micro-ring modulators 112 encodes the weights, each of which can be positive- or negative-valued. This can be modeled with transmission and reflection coefficients, i.e., αₘₙ^{(T)}=tₘₙα₀ and αₘₙ^{(D)}=rₘₙα₀. If the micro-ring modulators 112 are critically coupled to the upper waveguide/top port (K₁=K₂+K_{abs}), then these coefficients are:

$${t}_{mn} = \frac{i {Δ}_{mn}}{i {Δ}_{mn} + κ / 2} , {r}_{mn} = \frac{- \sqrt{{κ}_{1} {k}_{2}}}{i {Δ}_{mn} + κ / 2} \qquad ( 2 )$$

where Δₘₙ is the cavity detuning of the m^{th} ring modulator 112 (couples to ωₘ) at time step n.

The PBS 115 combines the through- and drop-port outputs of the ring modulators 112 to orthogonal polarizations of a polarization-maintaining output fiber (PMF) optical fiber link 121, which transmits the combined through- and drop-port outputs to the client 130 as a weight signal. If the through and drop beams have the same polarization (e.g., transverse electric (TE)), there may also be a polarization rotator coupled to one input port of the PBS 115 to rotate the polarization of one input to the PBS 115 (e.g., from TE to transverse magnetic (TM)), so that the inputs are coupled to the same output port of the PBS 115 as orthogonal modes (e.g., TE and TM modes propagating in the same waveguide 121). The optical link 120 may be over fiber or free space and may include optical fan-out to multiple clients as explained above. If the link loss or fan-out ratio is large, the server output can be pre-amplified by an erbium-doped fiber amplifier (EDFA) or another suitable optical amplifier (not shown).

At the end of the link 120, the weight signal enters the client 130, where the second PBS 131 separates the polarizations and the phase shifter 132 (FIG. 1) corrects for any relative phase shift due to polarization-mode dispersion accrued in the link 120. These inputs αₘₙ^{(T)}, αₘₙ^{(D)} are mixed using the broadband, traveling-wave MZM 133, whose voltage encodes the current activation xₙ as shown in FIG. 2. The output of the MZM 133 is:

$$[ \begin{matrix}{a}_{mn}^{( + )} \\ {a}_{mn}^{( - )}\end{matrix} ] = [ \begin{matrix}cos {θ}_{n} & - sin {θ}_{n} \\ sin {θ}_{n} & cos {θ}_{n}\end{matrix} ] [ \begin{matrix}{a}_{mn}^{( T )} \\ {a}_{mn}^{( D )}\end{matrix} ] = [ \begin{matrix}{t}_{mn} cos {θ}_{n} - {r}_{mn} sin {θ}_{n} \\ {t}_{mn} sin {θ}_{n} + {r}_{mn} cos {θ}_{n}\end{matrix} ] {a}_{0} \qquad ( 3 )$$

Finally, the WDM channels are demultiplexed using the ring resonators 134 and the power in each channel is read out on a corresponding photodetector 135. In this case, with a ring-based WDM transmitter, the difference current between the MZM outputs evaluates to:

$$\begin{matrix}Δ {I}_{mn} ≡ {I}_{mn}^{( + )} - {I}_{mn}^{( - )} \\ = {\vert {a}_{mn}^{( + )} \vert}^{2} - {\vert {a}_{mn}^{( - )} \vert}^{2} \\ = [ {\vert {t}_{mn} cos {θ}_{n} - {r}_{mn} sin {θ}_{n} \vert}^{2} - {\vert {t}_{mn} sin {θ}_{n} + {r}_{mn} cos {θ}_{n} \vert}^{2} ] \vert {a}_{0} \vert \\ = [ \underbrace{( {\vert {t}_{mn} \vert}^{2} - {\vert {r}_{mn} \vert}^{2} )}_{weight {w}_{mn}} \underbrace{cos ( {θ}_{n} )}_{input {x}_{n}} ] {\vert {a}_{0} \vert}^{2}\end{matrix} \qquad ( 4 )$$

The first term in Eq. (4) is a product between a DNN weight (encoded as |tₘₙ|²−|rₘₙ|²) and an activation (encoded as cos(2θₙ)). The second term Re[t*ₘₙrₘₙ]sin(2θₙ) is unwanted: it comes from interference between the through- and drop-port outputs on the MZM 133. This interference can be suppressed or eliminated by ensuring the fields are ±π/2 out of phase (true in the critically coupled case Eq. (2)), by offsetting them with a time delay (though this reduces the throughput by a factor of two), or by using two MZMs rather than one (at the cost of extra complexity).

NetCast uses time multiplexing, and the matrix-vector product is derived by integrating over multiple time steps. For clarity, label the wavelength channels with index m and time steps with index n. In each time step n, the weight server 110 outputs a column of this matrix w_{:,n}, where the weights are related to the modulator transmission coefficients (and hence the detuning) and the activation xₙ is encoded in the MZM phase:

$${w}_{m , n} = {\vert {t}_{mn} \vert}^{2} - {\vert {r}_{mn} \vert}^{2} = \frac{{Δ}_{mn}^{2} - {κ}_{1} {κ}_{2}}{{Δ}_{mn}^{2} + {( κ / 2 )}^{2}} \\ {x}_{n} = cos ( 2 {θ}_{n} ) \qquad ( 5 , 6 )$$

For lossless modulators (k₁=k₂=k/2), the range of accessible weights is wₘₙ∈[−1, +1]; for lossy modulators, the lower bound is stricter: wₘₙ∈[−1, +1]; wₘₙ∈[−1+2k_{abs}/k, +1]. To reach all activations in the full range xₙ ∈[−1,1], the modulation should hit all points in θ∈[−π/2,]; [−π/2,π/2]; this condition can be achieve using a driver with Vₚₚ=V_{π}.

After integrating Eq. (4) over the time steps, the difference charge for detector pair m is:

γₘ=ΣₙΔIₘₙ=Σₙwₘₙxₙ (7)

which is the desired matrix-vector product.

At a high level, the NetCast architecture encodes the neural network (the weights) into optical pulses and broadcasts it to lightweight clients 130 for processing, hence the name NetCast.

### NetCast Architecture Variants

The NetCast concept is very flexible. For example, if one has a stable local oscillator, one can use homodyne detection rather than differential power detection to create a coherent version. While NetCast does not rely on coherent detection or interference, coherent detection can improve performance. In addition, one can replace the fast MZM with an array of slow ring modulators to integrate the signal over frequency rather than time (computing x^{T}w instead of wx). Finally, there are a number of ways to reduce the noise incurred in differential detection if many of the signals are small.

### Coherent NetCast

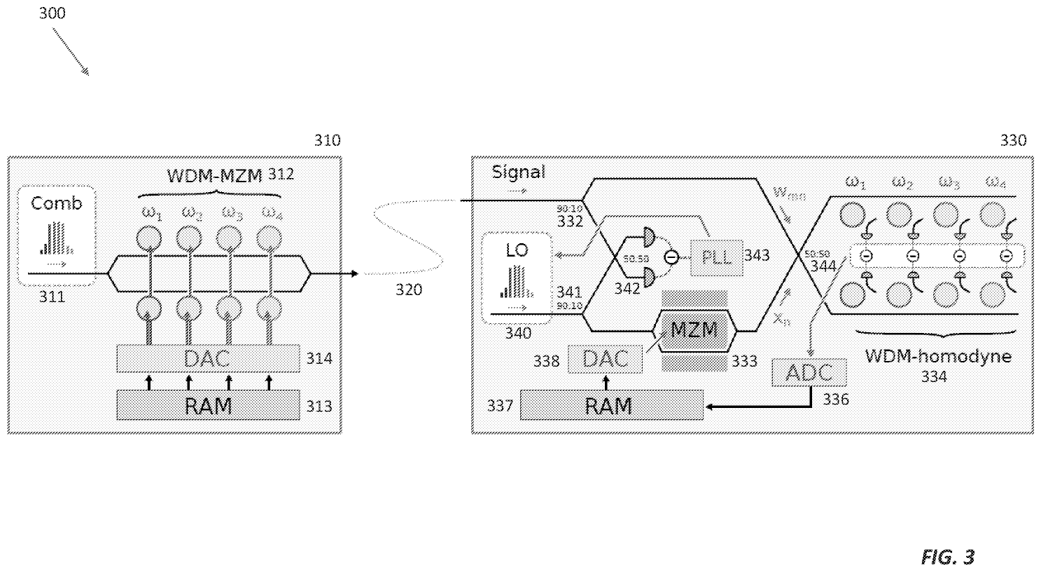

FIG. 3 shows a schematic of an example coherent NetCast architecture 300. Like the incoherent architecture 100 in FIG. 1, the coherent architecture 300 in FIG. 3 includes a weight server 310 coupled to one or more clients 330 via respective optical links 320 (for simplicity, FIG. 3 shows only one optical link 320 and only one client 330). The weight server 310 includes a frequency comb source 311, such as a mode-locked laser, that is optically coupled to a WDM-MZM 312. The WDM-MZM modulates the amplitude of each frequency channel independently. For concreteness, FIG. 3 shows a ring-based implementation, which includes one pair of ring resonators for each WDM channel, with one half each ring resonator pair evanescently coupled to one arm of the MZM, and the other half evanescently coupled to the other arm. The ring resonators in the WDM-MZM 312 can be tuned with a DAC 314 based on weights stored in a RAM 313 or other memory.

This architecture 300 is called a coherent architecture because the weight data is encoded in coherent amplitudes, and the client 330 performs coherent homodyne detection using a local oscillator (LO) 340. A tap coupler (e.g., a 90:10 beam splitter) 341 couples a small fraction of the output of the LO 340 to one port of a differential detector 342 and the remainder to the input of an MZM 333. Likewise, the other port of the differential detector 342 receives a fraction of the weight signal from the server 310 via another tap coupler 332. The output of the differential detector 342 drives a phase-locking circuit 343 that stabilizes the carrier frequency and repetition rate of the LO 340 in a phase-locked loop (PLL). The second tap coupler 332 couples the remainder of the weight signal to a 50:50 beam splitter 344 at whose other input port is coupled to the output of the MZM 333. The output ports of this 50:50 beam splitter 344 are fed to respective input ports of a WDM homodyne detector 334.

For concreteness, FIG. 3 shows an implementation based on ring drop filters, which has ring resonator pairs coupled to respective differential detectors as in the client 110 of FIG. 1. Each ring resonator pair in the WDM homodyne detector 334 is tuned to a different WDM channel so that each differential detector sends the homodyne interference between the corresponding weight signal and LO WDM channel. An ADC 336 digitizes the outputs of the WDM homodyne detector 334 for storage in a RAM 337, which also store in the DNN layer inputs for driving the MZM 333. A DAC 338 converts the digital DNN layer inputs from the RAM 337 into analog signals for driving the MZM 333.

As in FIG. 1, the weights wₘₙ are generated at the server 310 in a time-frequency basis by modulating the lines of a frequency comb and broadcasting the resulting weight signal to the client 330 over the optical link 320. The coherent client 330 in FIG. 3 encodes data in the complex amplitude of the field rather than its power and uses a single polarization. An identical frequency comb from the LO 340 at the client 330 serves as the LO signal for measuring this complex amplitude. A fraction of the LO signal power is mixed with the weight signal to generate a beat note detected by the differential detector 342 and used by the phase-locking circuitry 343 in order to lock the LO comb to the server's comb. The remainder of the LO comb is amplitude-modulated in the MZM 333, which scales the LO comb amplitude by the activations xₙ. The wavelength-demultiplexed homodyne detector 334 accumulates the products wₘₙxₙ, which integrate out to give the matrix-vector product just as in the incoherent case.

One advantage of coherent detection at the client 330 is increased data rate. The coherent scheme shown in FIG. 3 and described above encodes data in a single quadrature and polarization. By encoding data in both quadratures and both polarizations, the coherent scheme shown in FIG. 3 offers four times the capacity of the incoherent scheme shown in FIGS. 1 and 2.

Another advantage of the coherent scheme is increased signal-to-noise ratio (SNR), especially at low signal powers. This is especially relevant for long-distance free-space links where the transmission efficiency is very low. Homodyne detection with a sufficiently strong LO allows this signal to be measured down to the quantum limit, rather than being swamped by Johnson noise.

Assume that inputs and weights are scaled to lie in the range xₙ, wₘₙ∈[−1,1]. The comb line amplitudes input to the homodyne detector, normalized to photon number, are αₘₙ^{(w)}=α_{w}wₘₙ and αₘₙ^{(x)}=αₓxₙ. In the weak-signal limit α_{w}«αₓ, the difference charge accumulated on each photodetector, per time step, is:

[symbol]

Q/e [symbol] =2α_{w}αₓwₘₙxₙ, [symbol] Q/e [symbol] ᵣₘₛ≡αₓ|xₙ| (8)

The mean and standard deviation of the output signal are therefore:

$$〈 {y}_{m} 〉 = {ρ}_{n} {w}_{mn} {x}_{n} , {〈 Δ {y}_{m} 〉}_{rms} = \frac{1}{{α}_{w}} {‖ x ‖}_{2} \qquad ( 9 )$$

As expected, the SNR depends inversely on the energy per weight pulse (before modulation) |α_{w}|². The ONN's performance may be impaired if the SNR is too low; this sets a lower bound to the optical received power, analogous to the ONN standard quantum limit.

The same protocol can also work if the weight data is sent over an RF link; in this case a mixer is used in place of an optical homodyne detector. An advantage of using an optical link is the much higher data capacity, driven by the 10⁴-10⁵× higher carrier frequency.

### Additional NetCast Variants

NetCast is very extensible: it can detect coherently or incoherently, integrate over frequency or time, and in the case of incoherent detection, additional complexity can lower the receiver noise.

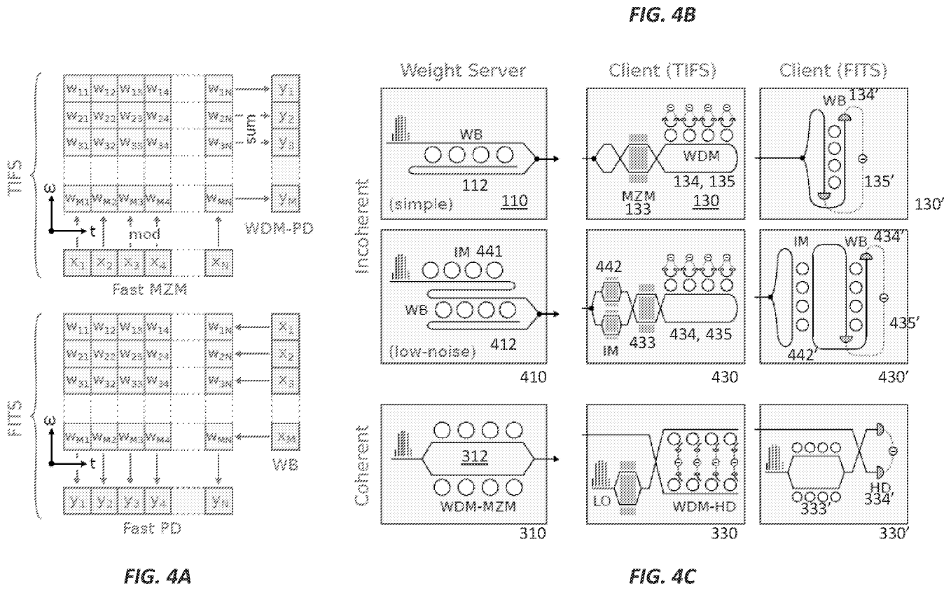

FIGS. 4A-4C shows different variants of NetCast. All of these variants encode the weight matrix in time-frequency space, where wₘₙ is the amplitude of wavelength band ωₘ at time step tₙ. FIG. 4A shows two possible matrix-vector multiplication schemes: right-multiplication γ=wx through Time Integration/Frequency Separation (TIFS; top) with a fast MZM and WDM-photodetector (PD) or left-multiplication γ^{T}=x^{T}w through Frequency Integration/Time Separation (FITS; bottom) with a fast photodetector (PD) and weight bank (WB) in the client. The weight bank serves to independently weight the power of the frequency channels; one possible implementation involves an array of ring resonators, which integrate over frequency with the activations xₘ encoded in the resonator detunings, as shown in FIG. 2. FITS uses a single fast detector pair, unlike the TIFS schemes where many slow detectors are employed.

FIG. 4B illustrates weight servers (left column), TIFS clients (middle column), FITS clients (right column) for simple incoherent detection (top row) and low-noise incoherent detection (bottom row). Simple incoherent detection can be carried out the weight server 100 and TIFS client 130 from FIGS. 1 and 2. It can also be carried out with a FITS client 130′ that uses a weight bank of ring resonators 134′ whose add and drop ports are coupled to different inputs of a differential detector 135′.

In the TIFS client 130, the optical signal is modulated by a broadband MZM 133, which modulates all wavelength channels simultaneously. This weights the columns of the weight matrix Wₘₙ by activations xₙ. The resulting wavelength channels are demultiplexed 134′ and the product is detected on the difference detector 135′ after time integration (sum over the rows of the weighted matrix, Σₘwₘₙxₘ).

In the FITS client 130′, the optical signal is sent through a weight bank 134, which independently modulates each wavelength channel. This weights the rows of the weight matrix wₘₙ by activations xₙ. The resulting signal is detected on a difference detector; at time step n, the difference current is the sum of all contributing wavelength channels (sum over the rows of the weighted matrix, Σₘwₘₙxₘ).

The low-noise incoherent servers 410 and clients 430 and 430′, shown in the bottom row of FIG. 4B, operate with lower noise than the incoherent servers 110 and clients 130 and 130′ (but not as low as the coherent servers 310 and clients 330 and 330′) and don't require an LO. Compared to the simple incoherent weight server 110, the low-noise incoherent weight server 410 has an additional wavelength-selective intensity modulator (IM) 441 before an array of micro-ring modulators 412. This wavelength-selective intensity modulator 441 can be implemented with an array of rings as shown in FIG. 4B. The intensity modulator 441 encodes the weight amplitudes |wₘₙ| onto the optical carrier while the micro-ring modulators 412 function in binary mode to encode the signs of the weights on onto the optical carrier. Similarly, in the TIFS client 430 an additional pair of intensity modulators 442 l coupled to the inputs of an MZM 433 as shown in FIG. 4B. The intensity modulators 442 attenuate the power according to the DNN input amplitude |xₙ|, while the MZM 433 works in binary mode to encode the sign of DNN input. Ring resonators 134 filter each WDM channel for detection by balanced photodetectors 435 as described above. The FITS client 430′ also includes an intensity modulator 442′ coupled to ring resonators 434′ whose add and drop ports are coupled to different inputs of a differential detector 435′.

FIG. 4C shows a weight server 310, TIFS client 330, and FITS client 330′ that operate using coherent detection. The weight server 310 and TIFS client 330 are described above with respect to FIG. 3. The FITS client 330′ uses a fast homodyne detector 334′ to detect the interference between the weight signal and an LO comb whose comb lines have been modulated with a WDM-MZM 333′ like the WDM-MZM 312 in the server 310 that generates the weight signal. One advantage of a homodyne scheme is low noise, which allows the ONN to operate at low received optical power, but the LO adds great complexity to the client 330′.

Simple and low-noise incoherent servers and clients can be mixed and matched depending on the desired neural network performance and system complexity. To show the advantage of the low-noise configurations, consider the following four cases, named S/S, S/LN, LN/S, LN/LN (simple server/simple client, simple server/low-noise client, etc.). In each case, start with an unweighted frequency comb with amplitudes α_{w}, where N_{wt}=|α_{w}|² is the number of photons per weight (at the source), and normalize variables so that w, x ∈[−1,1].
1. S/S: The weight bank (WB) encodes wₘₙ into the differential power in two channels, which are multiplexed with a PBS. These are |α±|²=(1/2)(1±Wₘₙ)N_{wt}. At the client, these channels are remixed with the MZM (avoiding interference) to give |α′±|²=(1/2)(1±wₘₙxₙ)N_{wt}. Thus the differential charge is Q_{det}=|α′+|²−℄α′−|²=wₘₙxₙN_{wt}, while the total absorbed charge, which sets the shot noise, is Qₜₒₜ=|α′+|²+|α′−|²=N_{wt}.
2. S/LN: The inputs are the same as in S/S, but the client has an additional pair of intensity modulators (IM) before the MZM as shown in FIG. 4B. The IMs attenuate the power according to the amplitude |xₙ|, while the MZM works in binary mode to encode the sign (θₙ=arg(xₙ) ∈{0, π/2}). Thus, the photodetector (PD) input is either |α′±|²=(1/2)(1±wₘₙxₙ)N_{wt} for xₙ>0, or (1/2)(1∓wₘₙxₙ)N_{wt} for xₙ <0. Q_{det} is the same, but Qₜₒₜ is reduced by a factor of |xₙ|.
3. LN/S: In this case, a standard client is used but the weight server has an additional IM before the WB. This is wavelength-selective, which can be achieved with an array of rings as shown in FIG. 4B. As in the S/LN case, the IM encodes the amplitude |wₘₙ|while the WB functions in binary mode to encode the sign. Thus, a single polarization carries power: α₊=|wₘₙ|N_{wt} if wₘₙ>0, and α₋=|wₘₙN_{wt}|if wₘₙ<0. The PD input is |α′±|=(1/2)|wₘₙ|[1±sgn(wₘₙ)xₙ]N_{wt}, which gives the same Q_{det}, but Qₜₒₜ is reduced by a factor of |wₘₙ|compared to the S/S case.
4. LN/LN: If both server and client use low-noise designs, because the WB and MZM are always in BAR or CROSS mode, all the power ends up in one of the detectors: either |α′+|²=|wₘₙxₙ|N_{wt} for wₘₙxₙ>0, or |α′−|²=|wₘₙxₙ|N_{wt} for wₘₙxₙ<0. Thus Qₜₒₜ is reduced by a factor |wₘₙxₙ|.

TABLE 1

| Scheme | ${{Weights}^{†}}_{\begin{matrix}{\vert {a}_{+} \vert}^{2} / {N}_{wt} & {\vert {a}_{-} \vert}^{2} / {N}_{wt}\end{matrix}}$ | | ${PD {Input}^{†}}_{\begin{matrix}{\vert {a}_{+}^{′} \vert}^{2} / {N}_{wt} & {\vert {a}_{-}^{′} \vert}^{2} / {N}_{wt}\end{matrix}}$ | | PD Charge Qₜₒₜ/N_{wt} | Noise σₘ² × N_{wt} |
|---|---|---|---|---|---|---|
| S/S | $\frac{1}{2} ( 1 + {w}_{mn} ) \qquad \frac{1}{2} ( 1 - {w}_{mn} )$ | | $\frac{1}{2} ( 1 + {w}_{mn} {x}_{n} ) \qquad \frac{1}{2} ( 1 - {w}_{mn} {x}_{n} )$ | | 1 | N |
| S/LN | $\frac{1}{2} ( 1 + {w}_{mn} ) \qquad \frac{1}{2} ( 1 - {w}_{mn} )$ | | $\frac{1}{2} ( 1 + {w}_{mn} ) {x}_{n} \qquad \frac{1}{2} ( 1 - {w}_{mn} ) {x}_{n}$ | | \|xₙ\| | ∥x∥₁ |
| LN/S | wₘₙ | 0 | $\frac{1}{2} {w}_{mn} ( 1 + {x}_{n} ) \qquad \frac{1}{2} {w}_{mn} ( 1 - {x}_{n} )$ | | \|wₘₙ\| | ∥wₘ∥₁ |
| LN/LN | wₘₙ | 0 | wₘₙxₙ | 0 | \|wₘₙxₙ\| | Σₙ\|wₘₙxₙ\| |
| Coherent | — | — | — | — | — | $\frac{1}{4} {( {‖ x ‖}_{2} )}^{2}$ |

Comparison of the four incoherent schemes and the coherent scheme shown in FIGS. 4B and 4C. For incoherent schemes, the first three columns give the outputs of the weight server |a_{±}|², the client PD inputs |a′_{±}|², and the PD charge per step Qₜₒₜ (the differential charge is always Q_{det} = wₘₙxₙN_{wt}. The final column gives the noise amplitude (Eq. 10) for all schemes.
^{†}Weight and PD input powers for case wₘₙ > 0, xₙ > 0 shown. The other cases are analogous and Qₜₒₜ and Q_{det} do not change.

These cases are enumerated in Table 1. While they collect the same differential charge Q_{det}=wₘₙxₙN_{wt}, the total PD charge, which sets the shot-noise limit, varies considerably if many of the inputs or weights are small (or zero). This is generally true, especially for DNN weights which are often pruned to save memory.

From the PD charge, it is possible to calculate the shot noise on the logical output γₘ. In general, we will have:

γₘ=∈ₙwₘₙxₙ+N(0, σₘ²) (10)

The right column of Table 1 compares the noise amplitudes σₘ for the four incoherent schemes (as well as the coherent scheme, Eq. (9)). As expected, the low-noise and coherent schemes have lower noise amplitudes than the simple scheme. Also, because (∥x∥₂)²≤∥x∥₁ (application of Holder's inequality), the coherent scheme is superior to S/LN. But whether LN/LN or Coherent is best may depend on the weights.

Because time and frequency are Fourier conjugates, the noise analysis is the same for the FITS and TIFS integration schemes, with the replacements w→w^{T} and N→M (swap time bins with frequency channels). In addition, a side benefit of the low-noise schemes is robustness to phase errors: because the MZMs are always in a BAR or CROSS configuration, there is no interference between α₊ and α₋ and the relative phase no longer matters.

### Performance

### Throughput

If the client runs as a matrix-vector multiplier, e.g., as shown in FIGS. 1 and 2, it performs one MAC per weight received; thus, the client's throughput is limited by the optical link. A NetCast system may also have matrix-matrix clients with on-chip fan-out after the PBS 115 (FIG. 1); this increases the maximum throughput by a constant factor (k MACs per weight) at the expense of complexity (the client is duplicated k times over); nevertheless, link bandwidth still places a limit on throughput in this case.

Fundamentally, the channel capacity of the optical link between the server and client is usually limited by crosstalk. In this architecture, crosstalk takes two forms: (1) temporal crosstalk and (2) frequency crosstalk. Temporal crosstalk arises from the finite photon lifetime in the ring modulators and their finite RC time constant. Lumping these together gives an approximate modulator response time τ=\sqrt{1/k²+(RC)²}. For efficient modulators, RC ≈k, so τ≈\sqrt{2}/k. Temporal crosstalk can have the form Xₜ=e^{-T/96} , where T is the time between weights. This sets an upper limit on the symbol rate R=1/T of the modulators:

$$R \leq \frac{κ}{\sqrt{2} log ( 1 / {χ}_{t} )} = \frac{2 π {f}_{0}}{\sqrt{2} Q log ( 1 / {χ}_{t} )} \qquad ( 11 )$$

where ƒ₀ is the optical carrier frequency and Q is the ring's quality factor.

Frequency crosstalk occurs among channels of the WDM receiver (even for a perfect WDM, the transmitter rings have frequency crosstalk). This is set by the Lorentzian lineshape _{X ω}=(1/2K)²/(Δω²+(1/2K)²), where Δω is the spacing between neighboring WDM channels. In the low-crosstalk case Δω»K, this gives a minimum channel spacing:

$$Δω \geq \frac{κ}{2 \sqrt{χω}} = \frac{2 π {f}_{0}}{2 Q \sqrt{χω}} \qquad ( 12 )$$

Analog crosstalk should be sufficiently low for the DNN to function. An analog crosstalk of Xₜ≲0.05 is usually sufficient. Assuming spatial crosstalk has a similar threshold (Xₜ=X_{ω}=X), the channel capacity is bounded by:

$$C = R \frac{2 π B}{Δω} \leq \frac{2 π \sqrt{2 χ}}{log ( 1 / χ )} B ≡ {C}_{0} B \qquad ( 13 )$$

Here B is the bandwidth (in Hz) and C₀ is the normalized symbol rate (units 1/Hz-s).

Table 2 shows the capacity as a function of crosstalk. These values are in the same ballpark as the HBM memory bandwidth of high-end GPUs (e.g., 6-12 Tbps). In the matrix-vector case of 1 MAC/wt, it may not be possible to reach GPU- or TPU-level arithmetic performance (>50 TMAC/s). This could involve optical fan-out in the client to reuse weights (as mentioned above; GPUs and TPUs do this anyway) or operating beyond the C-band.

There may also be practical bandwidth limits set by dispersion in the MZM, long fiber links, PBS, or free-space optics. Many of these bandwidth limits can be circumvented with appropriate engineering.

TABLE 2
Maximum link bandwidth as a function of crosstalk. The
C-band is the wavelength range 1530-1565 nm where EDFAs
operate (B = 4.4 THz). The rightmost column gives the
equivalent digital data capacity, assuming 8-bit weights.
Laser Power/SQL

| Crosstalk | | Capacity C | |
|---|---|---|---|
| χ | Symbol rate C₀ | (C-band) | ×8 b/wt |
| 0.1 | 1.22 | 5.3 Twt/s | 43 Tbps |
| 0.05 | 0.66 | 2.9 Twt/s | 23 Tbps |
| 0.01 | 0.19 | 850 Gwt/s | 6.8 Tbps |
| 0.005 | 0.12 | 520 Gwt/s | 4.2 Tbps |
| 0.001 | 0.04 | 180 Gwt/s | 1.2 Tbps |

The server should emit enough laser power to maintain a reasonable SNR at the detector. The noise can be modeled as a Gaussian term in the matrix-vector product of each DNN layer. Following Eq. (10), one writes:

yₘ=∈ₙWₘₙxₙ+N(0, τ²), τ=\sqrt{τⱼ²+τₛ²} (14)

Here, τⱼ and τₛ are the Johnson- and shot-noise contributions, respectively. Johnson noise gives rise to so-called kTC noise fluctuations on the charge of a capacitor; these fluctuations scale as (ΔQ)ₘₛ=\sqrt{kTC} and can dominate for readout circuits (detector and transimpedance amplifier (TIA)) with large capacitance. Shot noise, due to the quantization of light into photons, may dominate in the case of high optical powers or coherent detection (with a strong LO).

There are at least two ways to define the basis for benchmarking laser power. First, the basis can be defined based on the source power in the frequency comb at the weight server before the WDM-MZM. Denote this as N_{src}. This is the same as N_{wt} used elsewhere in this specification. Second, the basis can be defined based on the transmitted power (averaged) at the weight server's output, denoted Nₜᵣ. This may be much lower than N_{src} if many weights are zero and a low-noise or coherent detection scheme is used. Received power (at the client) is just Nₜᵣ times the link efficiency. Source power is a convenient basis without practical amplifiers, but as long as it is possible to amplify the signal efficiently without too much dispersion, nonlinearity, or crosstalk, transmitted power may be a more convenient basis. Plus using transmitted power leads to more favorable results in many cases.

To calculate the energy bound imposed by noise in the ONN, consider running the neural network with additive Gaussian noise in each layer (Eq. (14)) and computing the noise limit, the largest tolerable noise amplitude τₘₐₓ. This depends on the DNN and the tolerance to error.

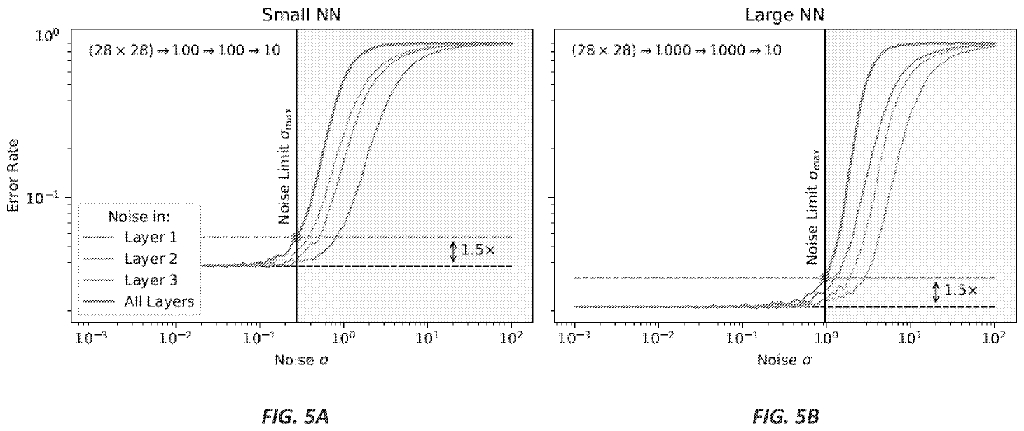

FIGS. 5A and 5B show the error rate as a function of τ for the MNIST perceptrons for small and large NNs, respectively. If noise increases the error by no more than 1.5×, then τₘₐₓ=0.27 for the small NN (100-neuron hidden layers) and 0.95 for the large NN (1000-neuron hidden layers).

The largest tolerable noise amplitude τₘₐₓ can be used to obtain a conservative estimate for the energy metric (either N_{src} or Nₜᵣ) since τ=\sqrt{τⱼ²+τₛ²} depends on the optical energy. First, the Johnson noise scales inversely with N_{src} and sets a lower bound on it:

$${σ}_{J} = \frac{\sqrt{kTc / {e}^{2}}}{{N}_{src}} ⇒ {N}_{src} > \frac{\sqrt{kTc / {e}^{2}}}{{σ}_{max}} \qquad ( 15 )$$

Table 3 lists the kTC noise, the corresponding minimum energy per MAC Eₘᵢₙ, and the minimum power (at a rate of 1 TMAC/s).

TABLE 3
Johnson (kTC) noise as a function of capacitance C and
corresponding minimum source energy per MAC Eₘᵢₙ.

| C = | 1 fF | 10 fF | 100 fF | 1 pF |
|---|---|---|---|---|
| [symbol] ΔQ/e [symbol] ᵣₘₛ | 13 | 40 | 130 | 400 |
| Eₘᵢₙ × σₘₐₓ | 1.6 aJ | 5.1 aJ | 16 aJ | 51 aJ |
| Pₘᵢₙ × σₘₐₓ^{†} | 1.6 μW | 5.1 μW | 16 μW | 51 μW |

^{†}Power Pₘᵢₙ calculated at 1 TMAC/s.

TABLE 4
Shot noise for the incoherent and NetCast schemes (Table 1)
and corresponding coefficients F_{src} and Fₜᵣ (Eq. (17)).

| | Noise | Coefficients | |
|---|---|---|---|
| Scheme | σ² | F_{src} | Fₜᵣ |
| S/S | N/N_{src} | 1 | 1 |
| S/LN | [symbol] \|xₙ\| [symbol] | [symbol] \|xₙ\| [symbol] | [symbol] \|xₙ\| [symbol] ² |
| | (N/N_{src}) | | |
| LN/S | [symbol] \|wₘₙ\| [symbol] | [symbol] \|wₘₙ\| [symbol] | [symbol] \|wₘₙ\| [symbol] ² |
| | (N/N_{src}) | | |
| LN/LN | [symbol] \|wₘₙxₙ\| [symbol] | [symbol] \|wₘₙxₙ\| [symbol] | [symbol] \|wₘₙ\| [symbol] [symbol] \|wₘₙxₙ\| [symbol] |
| | (N/N_{src}) | | |
| Coherent | [symbol] \|xₙ\| [symbol] | [symbol] \|xₙ²\| [symbol] | [symbol] \|xₙ\|² [symbol] [symbol] \|wₘₙ\|² [symbol] |
| | (N/N_{src}) | | |

The shot noise term as scales inversely with the square root of power. This sets a lower bound on the optical power called the Standard Quantum Limit (SQL) because it arises from fundamental quantum fluctuations in coherent states (rather than thermal fluctuations, which can be avoided with a sufficiently small capacitance, or using avalanching or on-chip gain before the detector). The SQL may be relevant here for two reasons: (1) optical power budgets are much lower owing to laser efficiency, free-carrier effects, and nonlinear effects—while chips can tolerate 100 W of heating, most silicon-on-insulator (SOI) waveguides take at most 100 mW; and (2) links can be very low efficiency in many applications (e.g., long-distance free-space). Therefore, unlike the HD-ONN, a NetCast system may operate near the SQL.

Define coefficients F_{src} and Fₜᵣ by:

$${σ}_{S} = \sqrt{{F}_{arc} \frac{N}{{N}_{src}}} = \sqrt{{F}_{tr} \frac{N}{{N}_{tr}}} \qquad ( 16 )$$

The power bound set by shot noise is therefore:

$${N}_{src} > {F}_{src} \frac{N}{{σ}_{max}^{2}} , {N}_{tr} > {F}_{tr} \frac{N}{{σ}_{max}^{2}} \qquad ( 17 )$$

Thus, the energy bound is closely related to the coefficients F_{src}, Fₜᵣ. These coefficients can be obtained by the form of τ (Table 1); Table 4 lists the coefficients for each scheme. As mentioned above, by reducing the noise in the case of sparse or nearly-sparse weights or activations ( [symbol] |xₙ| [symbol] , [symbol] |wₘₙ| [symbol] «1), low-noise designs can reduce the required laser power by a large factor. These factors F_{src} and Fₜᵣ, shown in Table 5 for the same MNIST neural networks, allow for a 10³× reduction in optical power consumption compared to the “simple” design.

At first glance, such a reduction seems unimportant because, even with the simple design, the noise-limited power is Eₘᵢₙ=1.4 fJ/MAC, sufficiently low that on-chip electronics, e.g., DACs, ADCs, and memory, are likely to dominate. However, this noise-limited power means that even at a modest throughput of 1 TMAC/s there should be 1.4 mW of optical power at the receiver. Given that lasers and EDFAs support at most 10-100 mW, this places a limit on the allowed optical fan-out, to say nothing of link loss or eye safety. For especially lossy links (e.g., drones connected at long distance over free space), there is a strong incentive to reduce Eₘᵢₙ as much as possible, even if it doesn't affect the client-side power budget.

Fortunately, both the coherent scheme and the LN/LN incoherent schemes can operate at very low transmitted energies of a few photons/MAC, enabling Pₘᵢₙ<1 μW even at 1 TMAC/s. With such a client, a 10 mW source can tolerate link losses (or fan-out ratios) of up to 10⁴. Alternatively, a lower-loss link could deliver enough power for 100 TMAC/s of computation, beating the TPU with a sub-mW (optical) power budget.

For the low-noise incoherent schemes, Johnson noise may dominate over shot noise because the shot-noise bound is so low. To suppress Johnson noise, signal pre-amplification (e.g., with an EDFA or a semiconductor optical amplifier) or avalanching detectors can be used.

TABLE 5

| | Source Power | | | | Transmitted Power | | | |
|---|---|---|---|---|---|---|---|---|
| Scheme | F_{src} | Nₘᵢₙ | Eₘᵢₙ | Pₘᵢₙ^{†} | Fₜᵣ | Nₘᵢₙ | Eₘᵢₙ | Pₘᵢₙ^{†} |

Small NN

| | | | | | | | | | | | | |
|---|---|---|---|---|---|---|---|---|---|---|---|---|
| S/S | 1.000 | 11,000 | 1.4 | fJ | 1.4 | mW | 1.000 | 11,000 | 1.4 | fJ | 1.4 | mW |
| S/LN | 0.092 | 1,300 | 160 | aJ | 160 | μW | 0.092 | 1,300 | 160 | aJ | 160 | μW |
| LN/S | 0.130 | 530 | 67 | aJ | 67 | μW | 0.020 | 57 | 7.2 | aJ | 7.2 | μW |
| LN/LN | 0.015 | 110 | 15 | aJ | 15 | μW | 0.002 | 6.0 | 770 | zJ | 770 | nW |
| Coherent | 0.061 | 1,100 | 140 | aJ | 140 | μW | 0.002 | 7.5 | 960 | zJ | 960 | nW |

Large NN

| | | | | | | | | | | | | |
|---|---|---|---|---|---|---|---|---|---|---|---|---|
| S/S | 1.000 | 1,100 | 140 | aJ | 140 | μW | 1.000 | 1,100 | 140 | aJ | 140 | μW |
| S/LN | 0.076 | 102 | 13 | aJ | 13 | μW | 0.076 | 102 | 13 | aJ | 13 | μW |
| LN/S | 0.091 | 175 | 23 | aJ | 23 | μW | 0.011 | 27 | 3.6 | aJ | 3.6 | μW |
| LN/LN | 0.009 | 17 | 2.2 | aJ | 2.2 | μW | 0.001 | 2.7 | 340 | zJ | 340 | nW |
| Coherent. | 0.048 | 86 | 11 | aJ | 11 | μW | 0.0007 | 1.5 | 180 | zJ | 180 | nW |

Coefficients F_{src} and Fₜᵣ in Eq. (17). Estimated minimum power required to achieve acceptable SNR (both at source (assuming no amplification) and transmitted power.
^{†}Power Pₘᵢₙ calculated at 1 TMAC/s.)

### Client Electrical Power Consumption

Electrical power consumption at the client depends on: (1) fetching activations (the inputs to the DNN layer) from client memory, (2) driving the MZM, and (3) reading and digitizing the detector outputs.

By broadcasting the weights from the server to the client(s), NetCast eliminates the need to retrieve weights from client memory. In general, the weights of a DNN take up much more memory than the activations. For a fully connected layer, weights take up O(N²) memory while activations only take up O(N) (batching evens this out a bit, but the size of the mini-batch is usually smaller than N). Moreover, unlike the weights, all of which should be stored somewhere, during inference only the current layer's activations need to be stored at any time (excepting branch points and residual layers). Thus, the ratio of weights to activations should increase with the depth of the network and the size of its layers.

Without the weights, the client may be able to store the entire DNN's state in on-chip memory, eliminating dynamic random-access memory (DRAM) reads on the client side. Moreover, even when reading from on-chip memory, there is a data reuse factor of M from wavelength multiplexing in the MZM as shown in FIG. 1. Thus, memory-related energy consumption by the client should be very low.

Driving the MZM at the client does not consume much electrical power either. A free carrier-based uni-traveling-carrier (UTC) MZM transmitter uses O(1) pJ/bit. As with the memory reads, WDM amortizes the driver cost over M channels, so the energy per MAC is O(1/M) pJ. With many channels, the driving cost can be driven below tens of femtojoules/MAC. (This assumes the MZM is UTC over the whole bandwidth and neglects dispersion). More exotic modulators (e.g., based on LiNbO₃, organic polymers, BaTiO₃, or photonic crystals) could reduce the modulation cost to femtojoules, which would again be amortized by the 1/M factor from WDM. However, few-fJ/MAC performance is already possible with modulators available in foundries today.

Reading and digitizing the detector outputs at the client also consumes small amounts of electrical power. Readout and digitization power consumption is usually dominated by the analog-to-digital conversion (ADC), which is O(1) pJ/sample at 8 bits of precision. It may be possible to scale ADC energies down to 100 fJ or less by sacrificing a bit or two without harming performance. In any event, after dividing by N >100, the ADC cost is at most tens of femtojoules/MAC.

The client may consume power for other operations, including tuning and controlling the ring resonators used as filters. Thermal ring tuning can raise the system-level power consumption figure for ring modulators from fJ/bit to pJ/bit. If the receiver WDM (designed with ring arrays as in FIG. 1) is not thermally stable, it may also be tuned thermally. Power consumption for thermal ring tuning can be reduced by using MEMS or carrier tuning.

### Server Electrical Power Consumption

In the highest power consumption scenario, the weight server stores all of its weights in DRAM and achieves zero local data reuse, so the power budget is dominated by DRAM reads (about 20 pJ/wt at 8-bit precision). At a target bandwidth of 1 Twt/s, this is approximately 20 W. The transmitter may add a few watts (assuming O(1) pJ/wt as before), and then there is the optical power considered earlier.

The NetCast server-client architecture can lead to entirely new dataflows because the server is freed from the tasks of computation and memory writes. For example, the weight server may be constructed as a wafer-scale weight server that stores the weights in static random-access memory (SRAM). With commensurate modulator improvements, the energy consumption can be reduced by orders of magnitude. In a wafer-scale server, the data should be stored locally to avoid both off- and on-chip interconnect costs.

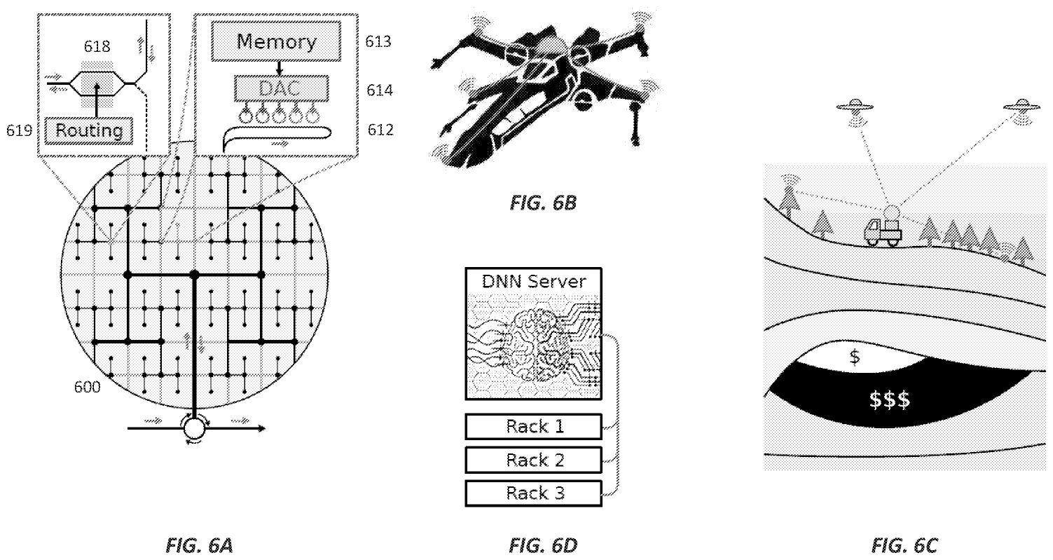

FIG. 6A shows an interlayer chip 600 that forms a low-power optical backbone for a weight server. Weights are stored in a regular array of SRAM blocks 613 on a wafer-scale (or multi-chiplet) processor. Each SRAM block 613 is coupled to its own WDM modulator array 612 via a corresponding DAC 614 and has enough memory to step through a small number of time steps (say, 100 time steps). The server can select SRAM blocks 613 on demand using a log-depth optical switching tree with MZMs 618 controlled by switching logic 619 at each intersection. The switching tree architecture is highly modular, making it possible to link together multiple wafer-scale servers if a model is too big for a single server. With a flexible photonic backbone (which could be built with slow but low-loss components, e.g., thermo-optic or MEMS components), servers could serve different models independently or pool their resources and build One Server to Rule them All.

At first glance, a switching tree may seem energy-intensive if each leaf on the tree contains one weight and the switches are toggled every clock cycle. But in this case, each leaf can contain many weights and can wait for many clock cycles before switching. This greatly reduces the burden on the switching network. Even in the case where weights are stored in DRAM, however, NetCast should operate at reasonable powers with existing technology.

### Applications for NetCast

There are many edge computing scenarios where smart sensors have a direct line of sight or a fiber-optic connection to a server but are power-starved. For example, complex machinery like aircraft contain hundreds of sensors that can be linked through fibers inside the airframe, as shown in FIG. 6B, while connecting them with wires may be cumbersome or dangerous or render the signals susceptible to electromagnetic interference. This is especially true in outer space, where long wires connecting chips are prone to electrostatic discharge during solar storms.

FIG. 6C illustrates NetCast used for surveying and field work, with Deep Learning brought to networks of solar- or battery-powered cameras, drones, and other internet-of-things (IoT) devices to aid tasks such as environmental monitoring, prospecting, and resource exploration. In this case, the optical fibers are replaced by pencil beams of smart light that broadcast the DNN weights to all devices within line-of-sight of the base station. A free-space transmitter coupled to server could use an accurate beam steering apparatus, potentially for multiple beams, that works for broadband signals for pointing, acquisition, and tracking of the client devices.

FIG. 6D shows NetCast deployed inside a data center, where a single DNN server optically serves multiple racks, each of which holds a client. If the same neural network is running on many users in parallel, this allows the bulk of the energy cost (weight retrieval) to be amortized over the number of racks. NetCast is more robust than other optical weight servers because (1) the incoherent versions of NetCast do not rely on coherent interference, and (2) there is a single mode to align, even for free-space links.

NetCast offers several advantages over other schemes of edge processing with DNNs. To start, it integrates the optical power in the analog domain and reads it out at the end, so the energy consumption is O(1/N) times smaller than digital optical neural networks. It can be used to implement large DNNs (e.g., with more than 10⁸ weights), which is not possible with today's integrated circuits. It can operate without phase coherence, which relaxes requirements on the stability of the links connecting the server to the clients. In addition, the links are not imaging links; they can be fiber-optic links or single-mode free-space links with simple Gaussian optics. Finally, the chip area scales as O(M), not O(MN) or O(N²), because NetCast is output-stationary, unlike schemes that are weight-stationary.

### Distributed Training

Another exciting possibility is to perform distributed training using two-way optical links between the server and the client. Training allows the server to update its weights in real time from data being processed on the clients. This following method for training is compatible with NetCast and runs on similar hardware.

DNN training is a two-step process. First, the gradients of the loss function J with respect to activations Xₙ=∂J/∂xₙ,ψₘ=∂J/∂yₘ are computed by back-propagation. Within each layer, the backpropagation relation is:

$$\frac{\partial J}{\partial {x}_{n}} = {Σ}_{m} {w}_{mn} \frac{\partial J}{\partial {y}_{m}} ⇔ {χ}_{n} = {Σ}_{m} {w}_{mn} {ψ}_{n} \qquad ( 18 )$$

and between layers it is:

$$\frac{\partial J}{\partial {y}_{n}} {\vert}_{p} = {g}^{′} ( {x}_{n} ) {\vert}_{p} \frac{\partial J}{\partial {x}_{n}} {\vert}_{p + 1} ⇔ {ψ}_{n} {\vert}_{p} = {g}^{′} ( {x}_{n} ) {\vert}_{p} \times {χ}_{n} {\vert}_{p + 1} \qquad ( 19 )$$

In vectorized form, Eq. (18) can be written as the matrix product X=w^{T}ψ, while Eq. (19) is an elementwise weighting of the vector elements ψ=g′(x)X.

Second, compute the weight update δₘₙ=∂J/∂wₘₙ, i.e., the gradient of J with respect to the weights:

$$\frac{\partial J}{\partial {w}_{mn}} = {x}_{n} \frac{\partial J}{\partial {y}_{n}} ⇔ {δ}_{mn} = {ψ}_{m} {x}_{n} , \qquad ( 20 )$$

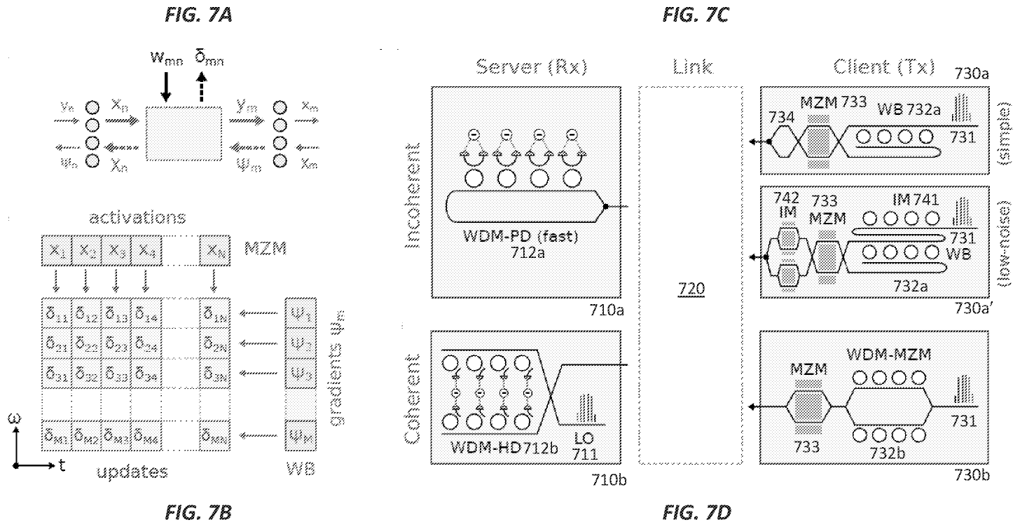

which is just the vector outer product δ=ψx^{T}. These relations are summarized in Table 6 and illustrated in FIG. 7A.

TABLE 6
Comparison of inference, backpropagation, and weight
updates. The first two can be cast as matrix-vector
multiplications with one optical input, an electrical
input, and an electrical output (O, E → E). The weight
update is different, taking the form of an outer product
between two electrical inputs to produce
an optical output ((E, E) → O).

| | Inputs | | Output | Format |
|---|---|---|---|---|
| Inference | Weights w | Activations x | Activations | (O, E) → E |
| | | | y = wx | |
| Backprop | Weights w | Gradients ψ | Gradients | (O, E) → E |
| | | | χ = w^{T}ψ | |
| Weight | Activations x | Gradients ψ | Updates | (E, E) → O |
| update | | | δ = ψx^{T} | |

Backpropagation relies on a matrix-vector product. In terms of optics, this is straightforward to perform in NetCast: simply swap w for w^{T} and everything runs the same as for inference. For the weight update, given the activation x and gradient ψ, compute the outer product δ=ωx^{T}, and transmit the result (encoded optically in a compatible format) to the server.

Since the weight update is a matrix, it can be encoded in the same time-frequency format as the weight matrix as shown in FIG. 7B. To obtain the inner product, the rows of the matrix are scaled by ψ and the columns are scaled by x. This can be done by sending a frequency comb through an array of slow wavelength-selective modulators (represented in FIG. 7B as a weight bank (WB) of ring resonators tuned to different resonance frequencies), then through a fast broadband MZM. When the optical signal reaches the server, it is demultiplexed and each wavelength channel is read out on an array of fast detectors.

FIGS. 7C and 7D illustrates three ways to perform this in hardware, analogous to the simple, low-noise, and coherent inference described above with respect to FIGS. 4B and 4C. FIG. 7C shows a server 710a (left) connected via an optical link 720 to a simple client 730a and/or a low-noise client 730a′ for (upper right) using incoherent detection at the server 710a. FIG. 7D shows a server 710b configured for coherent detection of training signals from another client 730b via the optical link 720.

In the simple client 730a of FIG. 7C, a mode-locked laser 731 generates a frequency comb, which is modulated by a weight bank (WB) of micro-ring modulators 732a and fed into an MZM 733. The WB's modulators 732a are set to transmit a fraction T=1/2(1+ψₘ) and reflect the remainder R=1/2(1−ψₘ). The MZM 733, which is set to θₙ=1/2cos⁻¹(xₙ), mixes these inputs but, if they are ±π/2 out of phase, no interference occurs and the power at each output port is given by |αₘₙ^{(±)}|²∝1/2(1±ψₘxₙ). These ports are combined on a PBS 734 and sent to the server 710a, which now functions as a receiver for weights. A WDM-PD receiver 712a in the server 730a separates the wavelengths with a passive WDM and at each time step computes the difference current, which is equal to the weight gradient:

Q_{det}=|αₘₙ⁽⁺⁾|²−|αₘₙ⁽⁻⁾|²∝ψₘXₙ=δₘₙ (21)

If many of the activations or weights are very small, it can be difficult to resolve the signal Q_{det} because of the large shot noise. The low-noise client 730a′ in FIG. 7C, analogous to the low-noise client 430 in FIG. 4B, resolves this problem. Here, the sign and amplitude of ψₘ are encoded on the frequency comb from the source 731 by the micro-ring modulators 732a and wavelength-selective intensity modulator (IM) 741, respectively; likewise, the sign and amplitude of xₘ are encoded in the MZM 733 and intensity modulator pair 742. As a result, only one of the polarizations carries power (depending on the sign of ψₘxₙ), and the power is |ψₘxₙ|. The detected difference charge is still given by Eq. (21), but the total charge is greatly reduced, along with the shot noise.

The coherent server 710b and client 730b share a common LO and so can encode the weights coherently. This involves cascading a frequency comb from a comb source 731 through a slow WDM-MZM 732b into a fast broadband MZM 733 on the client side and beating the resulting training signal against a LO comb from an LO 711 in a WDM homodyne detector 712b at the server 710b. In this case, the signal field (rather than power) scales as ψₘxₙ. With an LO amplitude α, the charge in each detector is Q_{±}=(1/2)(α±\sqrt{N_{src}}ψₘxₙ)² and the difference charge scales as ψₘxₙ.

TABLE 7
Comparison of the simple, low-noise, and coherent NetCast training schemes.

| | | Signal | | Noise | | |
|---|---|---|---|---|---|---|
| Scheme | Power Nₜᵣ/N_{src} | Q_{det} | (ΔQ²) | σ_{J}² × N_{src}² | σ_{S}² × N_{src} | σ_{S}² × Nₜᵣ |
| Simple | 1 | N_{src}ψₘxₙ | N_{src} | kTC/e² | 1 | 1 |
| Low-Noise | [symbol] \|ψₘ\| [symbol] [symbol] \|xₙ\| [symbol] | N_{src}ψₘxₙ | N_{src}\|ψₘxₙ\| | kTC/e² | [symbol] \|ψₘ\| [symbol] [symbol] \|xₙ\| [symbol] | [symbol] \|ψₘ\| [symbol] ² [symbol] \|xₙ\| [symbol] ² |
| Coherent | [symbol] \|ψₘ\|² [symbol] [symbol] \|xₙ\|² [symbol] | 2α\sqrt{N_{src}}ψmxₙ | α² | — | $\frac{1}{4}$ | $\frac{1}{4} 〈 {\vert {ψ}_{m} \vert}^{2} 〉 〈 {\vert {x}_{n} \vert}^{2} 〉$ |

Like inference, the accuracy of training in NetCast is limited by detector noise, which is a function of the optical power. In the large-signal limit, this noise leads to a Gaussian term in the calculated outer product:

δₘₙ=ψₘxₙ+N(0, τₘₙ²) (22)

While σₘₙ often depends on the specific matrix element, it can be more convenient to look at the average σ²=(σₘₙ²). This noise variance is a sum of Johnson and shot-noise terms σ²=σⱼ²+σₛ², which scale as σⱼ∝N_{src}⁻¹, σ_{S}∝N_{src}^{-1/2}. Table 7 compares the noise amplitudes for the three training schemes in FIGS. 7C and 7D. Consistent with the discussion above on inference, noise is greatly reduced if most |xₙ|(or |ψₘ|) are close to zero. Table 5 shows that [symbol] |xₙ| [symbol] <0.1 for a trained DNN; if this remains true in training and ψₘ is similarly sparse, the low-noise design can reduce noise (or reduce power at fixed noise) by a factor of 10³-10⁴ compared to the simple design. The noise reduction (or energy savings) of the coherent design may also be significant.

If training is really distributed, the server may receive weight updates from multiple clients. While the client-side power budget for weight transmission is quite low (O(M)+O(N) for an M×N matrix), on the server side, it is O(MN) since every weight is read to memory. If the server processes the weight updates of the clients independently, it may run into severe bandwidth and energy bottlenecks. Therefore, it can be highly advantageous to combine these updates optically before the server reads them out.

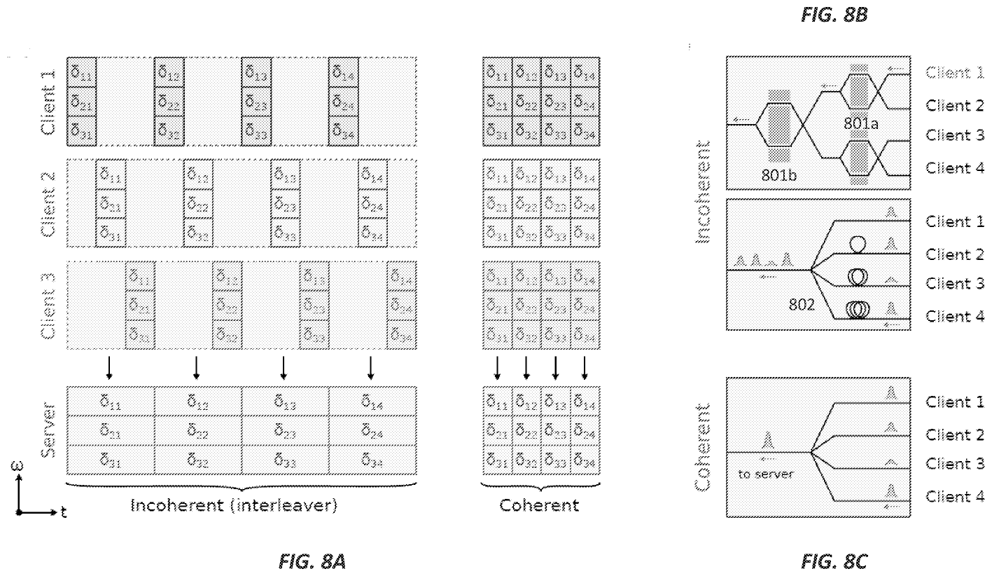

FIG. 8A illustrates combining the weight updates, in optics, before readout in the server. In the incoherent case, the updates are interleaved in time to avoid spurious interference terms between overlapping optical signals of undefined phase (which could manifest as noise). This can be done efficiently with a log-depth switching tree comprising fast MZM switches 801a and 801b to perform the interleaving as in the upper half of FIG. 8B. Alternatively, a passive combiner with time delays 802 can be used as a poor man's interleaver, at the cost of a factor-of-K power hit, where K is the number of clients as shown in the lower half FIG. 8B.

FIG. 8C shows that, by contrast, since the signals are already in phase in the coherent scheme, they can be combined without any interleaving using ordinary passive optics. This also entails a factor-of-K power loss but does not affect the SNR because the relevant information (the sum of all client fields) is preserved during the combination. One can see this by comparing the result of K separate homodyne measurements on fields αₖ, k ∈{1, . . . , K}:

\hat{α}ₖ=αₖ+N(0,1/4)⇒Σₖ\hat{α}ₖ=Σₖαₖ+N(0,1/4K) (23)

to first combining the fields optically (α=K^{-1/2}Σₖαₖ) and then performing homodyne detection:

\hat{α}ₖ=K^{-1/2}Σₖ+N(0,1/4)=K^{-1/2}[Σₖ\hat{α}ₖ+N(0, K/4)] (24)

The results in Eqs. (23) and (24) differ by a scaling factor; the SNR is the same. Therefore, in the coherent scheme, the weight updates can be combined without loss of signal. Beyond this, another advantage of the coherent scheme is speed: without interleaving, it is much faster in the case of many clients. In the incoherent case, interleaving can limit the weight update rate to the bounds derived above. By contrast, with coherent optics, these weight updates are optically batched and the bound no longer applies. This could be a major advantage in systems that have many clients and are (optical) throughput-limited.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, when a numerical range is expressed in terms of two values connected by the word “between,” it should be understood that the range includes the two values as part of the range.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method comprising:
at a server, generating a weight signal comprising an optical carrier modulated with a set of spectrally multiplexed weights for a deep neural network (DNN);
transmitting the weight signal from the server to a client via an optical link; and
at the client, computing a matrix-vector product of (i) the set of spectrally multiplexed weights modulated onto the optical carrier and (ii) inputs to a layer of the DNN.

2. The method of claim 1, wherein generating the weight signal comprises retrieving the set of spectrally multiplexed weights from a memory of the server.

3. The method of claim 1, wherein generating the weight signal comprises, at each of a plurality of time steps, modulating wavelength-division multiplexed (WDM) channels of the optical carrier with respective entries of a column of a weight matrix of the DNN.

4. The method of claim 3, wherein computing the matrix-vector product comprises:
modulating the weight signal with the inputs to the layer of the DNN;
demultiplexing the WDM channels of the weight signal modulated with the input to the layer of the DNN; and
sensing powers of the respective WDM channels of the weight signal modulated with the input to the layer of the DNN.

5. The method of claim 4, wherein modulating the weight signal with the inputs to the layer of the DNN comprises:
intensity modulating inputs to a Mach-Zehnder modulator with amplitudes of the inputs to the layer of the DNN; and
encoding signs of the inputs to the layer of the DNN with the Mach-Zehnder modulator.

6. The method of claim 1, wherein generating the weight signal comprises:
modulating an intensity of the optical carrier with amplitudes of the set of spectrally multiplexed weights before coupling the optical carrier into a set of ring resonators; and
modulating the optical carrier with signs of the set of spectrally multiplexed weights using the ring resonators.

7. The method of claim 1, wherein:
generating the weight signal comprises encoding the set of spectrally multiplexed weights in a complex amplitude of the optical carrier; and
computing the matrix-vector product comprises detecting interference of the weight signal with a local oscillator modulated with the inputs to the layer of the DNN.

8. The method of claim 1, wherein the spectrally multiplexed weights form a weight matrix and computing the matrix-vector product of (i) the set of spectrally multiplexed weights modulated onto the optical carrier and (ii) inputs to the layer of the DNN comprises:
weighting columns of the weight matrix with the inputs to the layer of the DNN to produce spectrally multiplexed products;
demultiplexing the spectrally multiplexed products; and
detecting the spectrally multiplexed products with respective photodetectors.

9. The method of claim 8, wherein weighting the columns of the weight matrix with the inputs to the layer of the DNN comprises simultaneously modulating a plurality of wavelength channels.

10. The method of claim 1, wherein the spectrally multiplexed weights form a weight matrix and computing the matrix-vector product of (i) the set of spectrally multiplexed weights modulated onto the optical carrier and (ii) inputs to the layer of the DNN comprises:
weighting rows of the weight matrix with the inputs to the layer of the DNN to produce temporally multiplexed products; and
detecting the temporally multiplexed products with at least one photodetector.

11. The method of claim 10, wherein weighting the rows of the weight matrix with the inputs to the layer of the DNN comprises independently modulating each of a plurality of wavelength channels.

12-20. (canceled)
